(19) United States
(12) Patent Application Publication
(10) Pub. No.: US 2013/0149788 A1
(43) Pub. Date: Jun. 13, 2013

(54) ASSAY FOR QUANTIFYING ELEMENTAL SULFUR LEVELS IN A SAMPLE

(71) Applicant: CORNELL UNIVERSITY, Ithaca, NY (US)

(72) Inventors: Gavin L. SACKS, Geneva, NY (US); Misha T. KWASNIEWSKI, Ithaca, NY (US)

(73) Assignee: CORNELL UNIVERSITY, Ithaca, NY (US)

(21) Appl. No.: 13/709,273

(22) Filed: Dec. 10, 2012

Related U.S. Application Data
(60) Provisional application No. 61/568,739, filed on Dec. 9, 2011.

(51) Int. Cl. G01N 31/22

(52) U.S. Cl. CPC G01N 31/224
USPC 436/123; 422/430

(57) ABSTRACT

The present invention relates to a method for quantifying elemental sulfur levels in a test sample. This method involves the steps of: (i) providing a test sample having an unknown amount of elemental sulfur; (ii) converting the elemental sulfur contained in the test sample into volatilized hydrogen sulfide using benign reagents and without prior need to purify the elemental sulfur in the test sample by extraction or other purification processes; and (iii) determining the amount of volatilized hydrogen sulfide from the test sample in order to quantify the amount of elemental sulfur contained in the test sample. The present invention also relates to kits, systems, and assays for quantifying elemental sulfur levels in a test sample.

### CROSS-REFERENCE TO RELATED APPLICATIONS

This application claims priority benefit of U.S. Provisional Patent Application Ser. No. 61/568,739, filed Dec. 9, 2011, the disclosure of which is hereby incorporated by reference in its entirety.

### FIELD OF THE INVENTION

The present invention relates to methods, kits, systems, and assays for detecting and quantifying elemental sulfur levels in a sample.

### BACKGROUND OF THE INVENTION

Currently, there are no rapid, inexpensive and field-appropriate approaches for detecting and quantifying part-per-million (ppm) or lower concentrations of elemental sulfur) (S⁰) in complex samples. Such approaches would be appropriate for users with little technical background and with minimal laboratory resources. Elemental sulfur measurements in field settings are relevant to a range of applications. For example, sulfur is widely used as fungicidal control against a common grapevine disease, powdery mildew, but 1 ppm sulfur residues at grape harvest can lead to increased production of noxious hydrogen sulfide (H₂S) gas during winemaking (A1). Similarly, elemental sulfur in gypsum drywall can be converted to hydrogen sulfide by molds, contributing to so-called “Chinese drywall syndrome” that has afflicted many homes in the past decade (A2). In both of these examples, rapid and simple measurement of trace level elemental sulfur would be of great utility.

Beyond these examples, quantitative sulfur measurements are also of importance to several fields of research, including geochemistry, petrochemicals, forensic analysis of explosives, wastewater treatment, and water analysis (A3).

Previous approaches to sulfur measurement require expensive equipment and/or toxic reagents, and thus are not appropriate for use in minimally equipped laboratories and/or untrained users. These methods are reviewed by Kamyshny et al. (A3) and Kwasniewski, et al (A4), and are outlined in FIG. 1. Generally, these approaches can be classified as either indirect, in which elemental sulfur is converted off-line to a more readily characterized product via one or more chemical reactions, or direct, in which the elemental sulfur is measured without a chemical conversion step by appropriate instrumentation.

A classic indirect approach for sulfur measurement in environmental samples is to convert elemental sulfur to thiocyanate by reaction with cyanide (A5). Thiocyanate can then be quantified colorimetrically by reaction with ferric chloride in an acetone solvent. This approach uses toxic reagents, particularly cyanide, and is thus not appropriate outside of a well-equipped research laboratory. The approach also requires operation of a specialized and expensive spectrophotometer.

Elemental sulfur can also be converted to sulfate by combustion, and the sulfate subsequently measured by ion chromatography (A6). An initial extraction using toluene is performed to avoid interferences from endogenous sulfate. Facilities for combustion or solvent extraction are not routinely available in minimally equipped laboratories.

Another indirect approach is to convert elemental sulfur to hydrogen sulfide following an extraction step using an organic solvent. Both chromium[II] (A 7) and hydrazine (A8) reagents have been employed to effect conversion of elemental sulfur to hydrogen sulfide. The hydrogen sulfide generated by this conversion can then be measured by a sulfide-selective electrode. Again, these approaches require toxic reagents or solvents and use of specialized instrumentation.

Related, but more laborious, indirect approaches involve treatment of elemental sulfur with copper metal following acetone extraction to produce copper sulfide (CuS) (A9). Addition of hot hydrochloric acid solution to CuS evolves hydrogen sulfide that subsequently reacts with cadmium[II] to generate cadmium sulfide (CdS), which can be quantified by an iodometric titration. An alternative approach is to react the CuS in the presence of barium salts under basic, oxidizing conditions to form barium sulfate, which can be measured gravimetrically (A10). Neither of these approaches is appropriate for field settings due to their tediousness and their requirement for organic solvents. These approaches also suffer from poor sensitivity.

Elemental sulfur can also be quantified directly without a prior chemical conversion step. High performance liquid chromatography with UV-visible detection (HPLC-UV/VIS) has been reported (A1, A11). Elemental sulfur is first extracted and pre-concentrated using an organic solvent prior to analysis. The approach is not appropriate for field settings and casual users due to the cost an HPLC system (>$10,000) as well as the need for a power supply and organic solvents. Furthermore, HPLC systems require trained operators to use and maintain.

Gas chromatography (GC) with either mass-spectrometric (GC-MS) (A12) or electron capture (GC-ECD) (A13) detectors can be used to directly detect and quantify elemental sulfur. An extraction step is performed with an organic solvent prior to GC analysis to concentrate the analyte and reduce the complexity of the matrix. GC-MS and GC-ECD offer excellent sensitivity and selectivity, and as a result are employed by at least one commercial analytical lab for quantification of elemental sulfur in suspect drywall samples (A14). However, the cost of a new GC-ECD system is >$10,000, and for a new GC-MS system is >$50,000, which is prohibitively expensive for use outside of dedicated laboratories. GC instruments also require skilled operators, and well-equipped laboratory environments, i.e., fume hoods for performing extractions, power supplies, and compressed gas cylinders for operation of the GC.

At least one publication has described the use of inductively coupled plasma-atomic emission spectroscopy (ICP-AES) to quantify elemental sulfur on grapes (A15). The authors reported washing the grape surface with a detergent to extract the sulfur. Since ICP-AES cannot distinguish elemental sulfur from other forms of sulfur, i.e. sulfate, it is not sufficiently selective to be used on most samples where elemental sulfur is a minor contributor to the total sulfur content. Additionally, ICP-AES systems are expensive and require trained operators.

Calibrated colorimetric test strips or detection tubes have been used to quantify hydrogen sulfide. In brief, these rely on a colorimetric reaction between gas phase hydrogen sulfide and a metal salt such as lead acetate, copper sulfate or mercuric chloride. However these tests rely on detecting the amount of hydrogen sulfide already existing in the sample and are not prepared to measure or detect the levels of elemental sulfur in the sample. Classically, these approaches have been used in the mining industry and environmental analyses to detect hydrogen sulfide in atmospheric samples. However, no reports have described a strategy for measuring elemental sulfur using a colorimetric tube approach.

The present invention is directed to overcoming these and other deficiencies in the art.

### SUMMARY OF THE INVENTION

In one aspect, the present invention relates to a method for quantifying elemental sulfur levels in a test sample. This method involves the steps of: (i) providing a test sample having an unknown amount of elemental sulfur; (ii) converting the elemental sulfur contained in the test sample into volatilized hydrogen sulfide using benign reagents and without prior need to purify the elemental sulfur in the test sample by extraction or other purification processes; and (iii) determining the amount of volatilized hydrogen sulfide from the test sample in order to quantify the amount of elemental sulfur contained in the test sample. As provided in this method, the amount of volatilized hydrogen sulfide produced in the converting step is proportionate to the amount of elemental sulfur contained in the test sample. Also as provided in this method, the converting and determining steps are performed substantially concurrently with one another.

In one embodiment of this method, the step of providing the test sample includes the steps of: (i) mixing the test sample with a sufficient amount of a non-toxic dispersing agent under conditions effective to disperse the elemental sulfur contained in the test sample; (ii) adjusting the pH of the test sample to a pH of between about 3.0 and about 9.0; and (iii) deaerating the test sample. In a particular embodiment, the adjusting the pH step and the deaerating step are performed in a single step by adding to the test sample a sufficient amount of a weak acid/weak base mixture effective to adjust the pH of the test sample to between about 3.0 and about 9.0 and to deaerate the test sample.

In one embodiment of this method, the step of converting the elemental sulfur contained in the test sample into volatilized hydrogen sulfide includes the steps of: (i) treating the test sample with a sufficient amount of a mild reducing agent under conditions effective to convert the elemental sulfur to hydrogen sulfide; and (ii) sparging the treated test sample with an inert gas to volatilize the hydrogen sulfide. In a particular embodiment, the inert gas of the sparging step is provided by adding to the treated test sample a weak acid/weak base mixture selected from the group consisting of: (i) a mixture of citric acid and sodium bicarbonate; (ii) a mixture of citric acid, calcium chloride, and sodium bicarbonate; and (iii) bicarbonate or carbonate salts, either alone or in combination with other neutral salts or acids and effective for adjusting the pH of the test sample to between about 3.0 and about 9.0 and to generate carbon dioxide.

In another embodiment of this method, the step of determining the amount of volatilized hydrogen sulfide from the test sample includes: (i) directing substantially all of the volatilized hydrogen sulfide to a hydrogen sulfide detection component; and (ii) using the hydrogen sulfide detection component to measure the amount of volatilized hydrogen sulfide produced from the test sample, where the amount of volatilized hydrogen sulfide measured by the hydrogen sulfide detection component is proportionate to the amount of elemental sulfur contained in the test sample.

In another aspect, the present invention relates to a kit for converting elemental sulfur from a test sample into volatilized hydrogen sulfide in situ and quantifying the elemental sulfur levels in the test sample. The kit includes: (a) a collection of reagents including the following: (i) a non-toxic dispersing agent effective to disperse elemental sulfur contained in a test sample; (ii) a weak acid/weak base mixture effective to adjust the pH of the test sample to between about 3.0 and about 9.0 and to deaerate the test sample; (iii) a mild reducing agent effective to convert the elemental sulfur to hydrogen sulfide without need for solvent extraction; (iv) a sparging agent effective to produce an inert gas to volatilize the hydrogen sulfide; and (v) a hydrogen sulfide detection component for quantifying the amount of volatilized hydrogen sulfide; (b) a reaction chamber for reacting the test sample with the collection of reagents; and (c) instructions for using the kit to convert elemental sulfur from a test sample into volatilized hydrogen sulfide in situ and to quantify the elemental sulfur levels in the test sample.

In another aspect, the present invention relates to a method for quantifying elemental sulfur levels in a test sample. This method includes the steps of: (a) providing a kit according to the present invention; (b) providing a test sample comprising an unknown amount of elemental sulfur; and (c) using the kit to perform the steps of: (i) converting the elemental sulfur contained in the test sample into volatilized hydrogen sulfide; and (ii) determining the amount of volatilized hydrogen sulfide from the test sample in order to quantify the amount of elemental sulfur contained in the test sample, where the amount of volatilized hydrogen sulfide produced in the converting step is proportionate to the amount of elemental sulfur contained in the test sample, and where the converting and determining steps are performed substantially concurrently with one another.

The invention provides an inexpensive and simple means for detecting and quantifying elemental sulfur at sub part-per-million concentrations in a range of complex matrices, including grapes. A buffered, dispersed sample is treated with a mild reducing agent to convert sulfur to hydrogen sulfide (H₂S). The H₂S evolved is concurrently volatilized and quantified or detected by a colorimetric reaction with a metal salt. In one embodiment, the invention can be used in field settings where trace sulfur impurities can lead to formation of noxious off-aromas, e.g., measuring sulfur pesticide in residues on wine grapes in wineries or sulfur contamination in drywall in homes.

These and other objects, features, and advantages of this invention will become apparent from the following detailed description of the various aspects of the invention taken in conjunction with the accompanying drawings.

### BRIEF DESCRIPTION OF THE DRAWINGS

For the purpose of illustrating aspects of the present invention, there are depicted in the drawings certain embodiments of the invention. However, the invention is not limited to the precise arrangements and instrumentalities of the embodiments depicted in the drawings. Further, as provided, like reference numerals contained in the drawings are meant to identify similar or identical elements.

FIG. 1 is a table that provides an overview of elemental sulfur detection methods in the art as compared to one embodiment of the method of the present invention.

FIG. 2 is a photograph of one embodiment of a reaction vessel used for quantifying elemental sulfur in accordance with the present invention. The reaction vessel as shown in FIG. 2 can be used as provided below. A test sample containing elemental sulfur is added to the bottom of the tube (reaction vessel) along with a reducing agent, dispersant, buffer, and carbonate-containing salt (see the “A” and “B” regions). The hydrogen sulfide evolved darkens the detection strip on the underside of the cap (see the “C” region), at a rate proportional to the amount of elemental sulfur in the sample.

FIG. 3 is a photograph of a close-up view of one embodiment of a detection strip on the underside of the reaction vessel cap of a reaction vessel of the type shown in FIG. 2.

FIG. 4 is a schematic of one embodiment of a detection system of the present invention. This figure shows an original Apparatus #1 for S⁰ measurement, adopted from Park [19]. H₂S formed following S⁰ reduction is purged from solution by a gas stream and detected by reaction with a metal salt containing sulfur detection tube.

FIG. 5 is a schematic of one embodiment of a detection system of the present invention. This figure shows Apparatus #2 and Summary of Assay. Following dispersion in PEG 400 (1:4 ratio), the sample is combined with 80 mL H₂O in a 120 mL glass screw-top flask (A) fitted with a 5 mL glass pipette as a condenser (B). The sample is buffered and deaerated by addition of an Alka-Seltzer tablet, and DTT is added along with another Alka-Seltzer tablet. The evolved H₂S is detected by a commercial sulfide detection tube (C).

FIG. 6 is an overview of reaction where S₈, the most common form of elemental sulfur, is reduced to H₂S by DTT based on the mechanism proposed for reduction of sulfur-sulfur bonds.

FIG. 7 shows the recovery of H₂S after incubation of S⁰ with DTT at different pH values. Recovery is reported as a percent of the maximum value achieved. (right) Recovery of H₂S following pre-extraction of S⁰-MS in water for 5 minutes, at different dilutions of PEG 400 in water.

FIG. 8 are graphs showing data from test results using one embodiment of the method and kit of the present invention to measure elemental sulfur residues on grapes during ripening.

### DETAILED DESCRIPTION OF THE INVENTION

The present invention relates to methods, kits, systems, and assays that enable the detection and quantification of elemental sulfur in test samples.

The methods and kits of the present invention are useful for detecting and quantifying elemental sulfur in test samples that include, without limitation, plant materials, plant residues, plant liquids or juices, foodstuffs, drywall samples, soils, rocks, water samples, wastewater, petrochemicals, explosive residues, and the like. In a particular example, the test sample can be taken from any plant exposed to elemental sulfur or exposed to a pesticide containing elemental sulfur. In one embodiment, the plant is selected from the group consisting of a fruit plant, a vegetable plant, a tuber or tuber-like plant, an ornamental plant, and a grain plant. In a more particular embodiment, the plant is selected from the group consisting of grapes, strawberries, raspberries, blueberries, apples, cherries, peaches, nectarines, pears, hops, and the like. In one particular embodiment, the methods and kits of the present invention are suitable for use in measuring elemental sulfur residues on grapes and their resulting musts.

In accordance with one aspect, the present invention provides a method for quantifying elemental sulfur levels in a test sample. This method involves the steps of: (i) providing a test sample having an unknown amount of elemental sulfur; (ii) converting the elemental sulfur contained in the test sample into volatilized hydrogen sulfide using benign reagents and without prior need to purify the elemental sulfur in the test sample by extraction or other purification processes; and (iii) determining the amount of volatilized hydrogen sulfide from the test sample in order to quantify the amount of elemental sulfur contained in the test sample. As provided in this method, the amount of volatilized hydrogen sulfide produced in the converting step is proportionate to the amount of elemental sulfur contained in the test sample. Also as provided in this method, the converting and determining steps are performed substantially concurrently with one another.

In one embodiment of this method, the step of providing the test sample includes the steps of: (i) mixing the test sample with a sufficient amount of a non-toxic dispersing agent under conditions effective to disperse the elemental sulfur contained in the test sample; (ii) adjusting the pH of the test sample to a pH of between about 3.0 and about 9.0; and (iii) deaerating the test sample.

In a particular embodiment, the pH of the test sample is adjusted to a pH of between about 3.5 and about 8.5, between about 4.0 and about 8.0, between about 4.5 and about 7.5, between about 5.0 and about 7.0, or between about 5.5 and 6.5. In another particular embodiment, the pH of the test sample is adjusted to a pH of about 6.0.

As used herein, the term “benign reagents” generally refers to reagents and/or chemicals suitable for use in the methods and kits of the present invention to convert elemental sulfur contained in a test sample into volatilized hydrogen sulfide without prior need to purify the elemental sulfur in the test sample by extraction or other purification processes. For example, as used herein, “benign reagents” include those reagents and/or chemicals that are effective to convert elemental sulfur to volatilized hydrogen sulfide in accordance with the methods and kits of the present invention without requiring a separate solvent extraction step. The term “benign reagents” also refers to reagents and/or chemicals that are non-toxic or of low toxicity, e.g., reagents and/or chemicals that are listed in Category 4 of the acute toxicity categories as recognized by the U.S. Environmental Protection Agency, or that can be disposed of without special consideration at the concentrations employed in the methods, assays, kits, and/or systems of the present invention. Thus, the term “benign reagents” as used herein does not include toxic organic solvents or other chemicals that are used for extracting elemental sulfur from a sample. Further, as used herein, the term “benign reagents” does not include toxic organic solvents or transition metal containing reagents, such as those used to purify or extract elemental sulfur using existing protocols. The term “benign reagents” also refers to reagents and/or chemicals used in the “providing a test sample” step and in the “determining the amount of volatilized hydrogen sulfide” step of the method of the present invention.

As used herein, the term “non-toxic dispersing agent” refers to any compound, composition, or other agent that is effective to disperse elemental sulfur in the test sample, and that is also considered a “benign reagent,” as defined herein. Suitable examples of non-toxic dispersing agents can include dispersing agents that are listed as having low acute toxicity in animal models. Further, suitable non-toxic dispersing agents can be dispersing agents that are water miscible or non-water miscible. Suitable examples of non-toxic dispersing agents that are water miscible solvents include, without limitation, polyethylene glycol (PEG), polypropylene glycol (PPG), and the like. Particular suitable examples of PEG include, without limitation, PEG-200, PEG-300, PEG-400, PEG-800, and PEG-1200. A particular suitable example of PPG includes, without limitation, PPG-400.

In a particular embodiment, the adjusting the pH step and the deaerating step are performed in a single step by adding to the test sample a sufficient amount of a weak acid/weak base mixture effective to adjust the pH of the test sample to between about 3.0 and about 9.0 and to deaerate the test sample.

As used herein, the term “weak acid/weak base mixture” refers to any mixture of compounds, compositions, or agents that comprise both a weak acid and a weak base, and that are also considered “benign reagents,” as defined herein. In certain embodiments, the weak acid/weak base mixture” functions as both a buffering agent and a deaerating agent. Suitable examples of weak acid/weak base mixtures in accordance with the present invention include, without limitation, the following: (i) a mixture of citric acid and sodium bicarbonate; (ii) a mixture of citric acid, calcium chloride, and sodium bicarbonate; or (iii) bicarbonate or carbonate salts, either alone or in combination with other neutral salts or acids and effective for adjusting the pH of the test sample to between about 3.0 and about 9.0 and to generate carbon dioxide. In a particular embodiment, the “weak acid/weak base mixture” can be, without limitation, antacid tablets such as ALKA-SELTZER® tablets (Bayer Healthcare, Morristown, N.J.) and the like.

In one embodiment of this method, the step of converting the elemental sulfur contained in the test sample into volatilized hydrogen sulfide includes the steps of: (i) treating the test sample with a sufficient amount of a mild reducing agent under conditions effective to convert the elemental sulfur to hydrogen sulfide; and (ii) sparging the treated test sample with an inert gas to volatilize the hydrogen sulfide.

As used herein, the term “mild reducing agent” refers to a chemical compound or mixture of compounds added to the test sample to convert elemental sulfur to hydrogen sulfide, and that is also considered a “benign reagent,” as defined herein. Suitable examples of mild reducing agents in accordance with the present invention include, without limitation, dithiothreitol (DTT), dithioerythritol (DTE), glutathione, cysteine, tris(2-carboxyethyl)phosphine (TCEP), and the like.

In a particular embodiment, the inert gas of the sparging step is provided by adding to the treated test sample a weak acid/weak base mixture, the weak acid/weak base mixture as described herein. The inert gas can include, without limitation, carbon dioxide, nitrogen, argon or other noble gases, and trifluoroethane or other fluorocarbons.

In another embodiment of this method, the step of determining the amount of volatilized hydrogen sulfide from the test sample includes: (i) directing substantially all of the volatilized hydrogen sulfide to a hydrogen sulfide detection component; and (ii) using the hydrogen sulfide detection component to measure the amount of volatilized hydrogen sulfide produced from the test sample, where the amount of volatilized hydrogen sulfide measured by the hydrogen sulfide detection component is proportionate to the amount of elemental sulfur contained in the test sample.

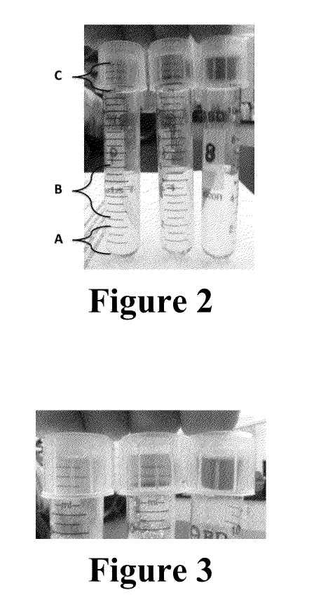

As used herein, the term “hydrogen sulfide detection component” refers to any device, apparatus, reaction site, mechanism, assay, or system that is effective for detecting and/or quantifying hydrogen sulfide, including volatilized hydrogen sulfide. Examples of suitable hydrogen sulfide detection components include, without limitation, hydrogen sulfide detection tubes and colorimetric assays comprising a paper strip impregnated with a transition metal salt selected from the group consisting of lead sulfate, mercuric chloride, copper chloride, cadmium chloride, and the like. Particular hydrogen sulfide detection tubes include, for example, SULFUR STICK™ hydrogen sulfide detection tubes (Sang Il Int'l Corp., South Korea) and GASTEC® 4LT, 4LL, and 4H hydrogen sulfide detection tubes (Gastec Corporation, Kanagawa, Japan). Further, in some embodiments, the hydrogen sulfide detection component can be a part of a reaction vessel (e.g., a colorimetric strip on the inside of a cap of the reaction vessel). Examples of various types of reaction vessels with hydrogen sulfide detection components are found in FIGS. 2-5.

In one embodiment, the method of the present invention can further including using an anti-foaming agent to prevent or decrease unwanted foaming during the converting and/or determining steps. If used, the anti-foaming agent also is one that meets the requirements as being a “benign reagent,” as defined herein. A suitable example of an anti-foaming agent for use in the present invention includes, without limitation, simethicone tablets (Quality Choice Extra-Strength Gas Relief, Novi, Mich.) and the like.

The methods of the present invention can be performed in a “reaction chamber.” As used herein, a “reaction chamber” refers to any vessel that is suitable for performing the methods as provided herein. In view of the disclosure provided herein and the general knowledge in the relevant art, those of ordinary skill in the art can readily determine suitable vessels for use as a reaction chamber in the present invention. Examples of suitable reaction chambers include, without limitation, beakers, flasks, test tubes, and the like. In certain embodiments, the term “reaction vessel” is used synonymously with the term “reaction chamber.”

In accordance with another aspect, the present invention provides a kit for converting elemental sulfur from a test sample into volatilized hydrogen sulfide in situ and quantifying the elemental sulfur levels in the test sample. The kit includes: (a) a collection of reagents suitable for use in converting elemental sulfur from a test sample into volatilized hydrogen sulfide in situ and quantifying the elemental sulfur levels in the test sample; (b) a reaction chamber for reacting the test sample with the collection of reagents; and (c) instructions for using the kit to convert elemental sulfur from a test sample into volatilized hydrogen sulfide in situ and to quantify the elemental sulfur levels in the test sample.

As used herein, the “collection of reagents” provided with the kit include at least the following: (i) a non-toxic dispersing agent effective to disperse elemental sulfur contained in a test sample; (ii) a weak acid/weak base mixture effective to adjust the pH of the test sample to between about 3.0 and about 9.0 and to deaerate the test sample; (iii) a mild reducing agent effective to convert the elemental sulfur to hydrogen sulfide without need for solvent extraction; (iv) a sparging agent effective to produce an inert gas to volatilize the hydrogen sulfide; and (v) a hydrogen sulfide detection component for quantifying the amount of volatilized hydrogen sulfide. In one embodiment, the collection of reagents can further include an anti-foaming agent. The reagents of the “collection of reagents” provided in the kit of the present invention are as further described herein.

In accordance with another aspect, the present invention provides a method for using the kit of the present invention to quantify elemental sulfur levels in a test sample. This method includes the steps of: (a) providing the kit according to the present invention; (b) providing a test sample comprising an unknown amount of elemental sulfur; and (c) using the kit to perform the steps of: (i) converting the elemental sulfur contained in the test sample into volatilized hydrogen sulfide; and (ii) determining the amount of volatilized hydrogen sulfide from the test sample in order to quantify the amount of elemental sulfur contained in the test sample, where the amount of volatilized hydrogen sulfide produced in the converting step is proportionate to the amount of elemental sulfur contained in the test sample, and where the converting and determining steps are performed substantially concurrently with one another.

In accordance with another aspect, the present invention provides a system for quantifying elemental sulfur levels in a test sample. In one embodiment, the system includes: (i) a collection of reagents suitable for use in converting elemental sulfur from a test sample into volatilized hydrogen sulfide in situ and quantifying the elemental sulfur levels in the test sample; and (ii) a reaction chamber for reacting the test sample with the collection of reagents. In one embodiment, the system further includes a hydrogen sulfide detection component, as described herein. In various embodiments, the system of the present invention is suitable for performing the methods of the present invention and using the kits of the present invention as described herein.

The methods, assays, systems, and kits of the present invention improve upon previous indirect approaches for elemental S previously described in which S is chemically reacted to first form H₂S. These previous methods are not generally appropriate for field use outside of a laboratory environment.

Below are some attributes that distinguish various embodiments of the method of the present invention from previous indirect approaches to measuring elemental S, as follows:

(i) The elemental S is not extracted into an organic solvent prior to chemical conversion to a more readily measured chemical species. Instead, a water miscible solvent, polyethylene glycol (PEG), is added to the sample to disperse the elemental S. This eliminates the use and disposal of more toxic organic solvents, and reduces the complexity of the protocol by eliminating the extraction step.

(ii) Prior to addition of the reducing agent, a buffering agent is used to conveniently buffer the sample to an appropriate pH and the sample is de-aerated. As provided in the present invention, use of a commercial bicarbonate/antacid tablet can be used to accomplish both these tasks.

(iii) A mild organic reducing agent is used to convert the elemental S to H₂S, in place of transition metals or more dangerous organic reducing agents like hydrazine.

(iv) The H₂S formed in situ, proportional to the initial elemental S concentration, is detected or quantified by colorimetric reaction with a metal-salt impregnated strip. This approach is simpler and less expensive than previous approaches which relied on sulfide ion selective electrodes, spectrophotometry, and/or elaborate wet chemical approaches to quantify H₂S following its formation from S.

(v) The combination of the features listed above as (i)-(iv) results in a convenient protocol for detecting or quantifying elemental S in a single reaction vessel.

### A Particular Embodiment of the Elemental Sulfur Detection Method

In one embodiment, the method of the present invention utilizes a reaction vessel and a two step process. The first step involves conversion of elemental S to H₂S using mild reducing conditions without an initial extraction step. The second step involves indirect quantification of S by colorimetric reaction of the H₂S formed with a metal salt. The steps of a particular embodiment of the method of the present invention are further described below, as follows:

### Step 1: Conversion of S to H₂S Via Mild Reducing Agent in Polyethylene Glycol:

A solid or liquid sample is mixed with polyethylene glycol and the mixture is heated to disperse the elemental S in the sample. Water is then added to the flask, and the sample is deaerated, and pH buffered to between 5.5 and 6.5. A mild reducing agent is added to convert elemental S to H₂S, and the sample is sparged with an inert gas to direct the H₂S evolved to a colorimetric detection tube.

A particular process for the conversion step uses 0.25-0.5 g sample sizes added to a 10-20 mL vessel or 0.5-5 g in a 100-150 mL vessel. The sample is dispersed in polyethylene glycol, such as PEG-400, at a ratio of 4 parts PEG-400 to 1 part sample. Water is then added at a ratio of at least 1 part water to 1 part PEG-400. The PEG-400/sample mixture is heated at 80° C. for 5 minutes to disperse the elemental S. The sample mixture is buffered to pH 6.0±0.10 and deaerated. This may be accomplished by addition of a commercial antacid tablet to the sample mixture. Following deaeration, a reducing agent, such as dithiotreitol (DTT), is added to yield a final concentration of >2 mM to serve as a reducing agent to generate H₂S from elemental S. With this approach, sub part-per-million detection thresholds and excellent conversion efficiency of S to H₂S, 75-100%, can be achieved.

### Step 2: Indirect Detection of S by Measurement of H₂S Formed Via Reduction Reaction:

Following its formation, the H₂S is volatilized and brought into contact with a transition metal salt, forming an insoluble darkly colored precipitate. The amount of precipitate formed is proportional to the amount of elemental S present in the original sample. Elemental S concentration in samples can be calculated by use of H₂S calibration standards and assuming a stoichiometric relationship between H₂S and elemental S, or by use of elemental S calibration standards.

A particular process for the detection step involves addition of a commercial antacid tablet, and capping the tube, where the underside of the cap contains an immobilized paper strip impregnated with lead sulfate. The paper strip will then react with the H₂S evolved, and the amount of darkening will be proportional to the original elemental S concentration in the sample. A second antacid tablet may need to be added to confirm that the reaction has completed.

As provided herein, the method of the present invention combines these two steps and can be performed in a single reaction vessel, as depicted in FIG. 2. The sample and PEG-400 are mixed in the bottom of the test tube (A) and then heated to disperse the sample. Water is then added to approximately double the volume (B). The sample is deaerated and buffered by addition of an antacid tablet portion. DTT is then added along with another antacid table. The sample is then capped. A lead sulfate impregnated paper strip is attached to the underside of the cap by an adhesive prior to capping. As shown in FIG. 3, samples containing more elemental S will darken the strip more (FIG. 3, right) than samples with less elemental S (FIG. 3, left). The distance of the strip reacted is proportional to the concentration of elemental S present. Elemental S can be quantified in unknown samples by comparing responses to calibration standards with known elemental S concentrations.

### Additional Embodiments of the Elemental Sulfur Detection Method

As an alternative to using a commercial antacid tablet to deaerate and buffer the sample, a mixture of pure citric acid, calcium chloride, and sodium bicarbonate can be added to the mixture to form CO₂ in situ. Other mixtures of acids and bicarbonate or carbonate salts can also be used to adjust the pH and generate CO₂.

As an alternative to using DTT as a reducing agent, other mild organic reducing agents can be employed. For example, glutathione, cysteine, tris(2-carboxyethyl)phosphine (TCEP) can all convert elemental S to H₂S but with lower recoveries than DTT.

As an alternative to adding all reagents individually, a mild reducing agent such as DTT, citric acid, and calcium chloride can be suspended in a solid plug of PEG-1500 at the bottom of a tube or flask. This strategy allows the reagent mixture to be prepared weeks or months before use, because the use of a solid form of PEG slows the oxidative degradation of the reducing agent. Other high molecular weight forms of PEG yield similar results. This approach may be more convenient for end users, since all reagents are present in the reaction vessel. A sample in water is then added to the reaction vessel, and the sample heated to 80° C. to melt the PEG 1500 and allow the sample and reagents to mix. The mixing is aided by the CO₂ produced from the reaction of citric acid and sodium bicarbonate citric acid reaction.

As an alternative to using a lead sulfate impregnated paper strip for colorimetric detection of H₂S formed from elemental S, strips impregnated with other transition metal salts, e.g. mercuric chloride or copper chloride, can be used to achieve a similar change.

As an alternative to using colorimetric paper strips attached to the reaction vessel cap, H₂S formed from elemental S can be measured by coupling the reaction vessel to an external sulfide detection tube. In this case, the length of the tube that darkens is proportional to the initial elemental S concentration.

The method of the present invention is expected to be useful in measurement of elemental S in complex matrices at trace concentrations (part per million or lower) in field settings or by users with little technical background. Through use of an appropriate solvent system, reaction vessels can be prepared with all reagents well ahead of time, which can further improve the convenience of the present invention for field use.

Some particular applications of the methods, assays, and kits of the present invention can include, without limitation, the following:

(i) Measuring Elemental S Residues on Grapes.

S is readily converted to H₂S during fermentation, which is a nuisance in the winery and can also lead to off-aromas in the finished wine. Measurements of S could occur in the vineyard to assist with harvest date decisions or determine the need to spray grapes with more S; or on harvested grapes in a winery prior to commencing fermentations.

(ii) Testing Drywall Samples for Elemental S Content.

High elemental S content in drywalls has been linked to production of H₂S in homes, resulting in corrosion of metal pipes and health effects to occupants. S measurements could be performed by contractors prior to installation; regulatory agencies interested in testing supplies; or consumers concerned about existing drywall in their homes.

(iii) Measurement of Elemental S in Research Labs Interested in a Convenient, Sensitive and Inexpensive Tool for Measuring S.

Fields interested in measuring elemental S include geochemistry, forensic science, and ecological sciences.

### EXAMPLES

The following examples are intended to illustrate particular embodiments of the present invention, but are by no means intended to limit the scope of the present invention.

### Example 1

Convenient, Inexpensive Quantification of Elemental Sulfur by Simultaneous In Situ Reduction and Colorimetric Detection

### 1. Abstract

Rapid, inexpensive, and convenient methods for quantifying elemental sulfur) (S⁰ with low or sub-μg g⁻¹ limits of detection would be useful for a range of applications where S⁰ can act as a precursor for noxious off-aromas, e.g., S⁰ in pesticide residues on winegrapes or as a contaminant in drywall. However, existing quantification methods rely on toxic reagents, expensive and cumbersome equipment, or demonstrate poor selectivity. We have developed and optimized an inexpensive, rapid method (˜15 min per sample) for quantifying S⁰ in complex matrices. Following dispersion of the sample in PEG-400 and buffering, S⁰ is quantitatively reduced to H₂S in situ by dithiothreitol and simultaneously quantified by commercially available colorimetric H₂S detection tubes. By employing multiple tubes, the method demonstrated linearity from 0.03-100 μg S⁰ g⁻¹ for a 5 g sample (R²=0.994, mean CV=6.4%), and the methodological detection limit was 0.01 μg S⁰ g⁻¹. Interferences from sulfite or sulfate were not observed. Mean recovery of an S⁰ containing sulfur fungicide in grape macerate was 84.7% with a mean CV of 10.4%. Mean recovery of S⁰ in a colloidal sulfur preparation from a drywall matrix was 106.6% with a mean CV of 6.9%. Comparable methodological detection limits, sensitivity, and recoveries were achieved in grape juice, grape macerate and with 1 g drywall samples, indicating that the methodology should be robust across a range of complex matrices.

In this example, described is the development, optimization, and validation of a safe, inexpensive, and novel method for S⁰ quantification, in which S⁰ is converted quantitatively to H₂S by a mild thiol reducing agent and simultaneously detected by commercial sulfide detection tubes. The approach was validated in three complex matrices for which convenient S⁰ measurement should have immediate utility: grape juice, grape macerate, and drywall.

Portions of this example and the figures cited herein were contained in Kwasniewski et al., “Convenient, Inexpensive Quantification of Elemental Sulfur by Simultaneous In Situ Reduction and Colorimetric Detection,” Analytica Chimica Acta, 703:52-57 (available online on Jul. 30, 2011).

### 2. Experimental

### 2.1 Chemicals

### 2.1.1 Commercially Purchased Chemicals

Cysteine, glutathione, mercaptoethanol, dithiothreitol (DTT), tris(2-carboxyethyl)phosphine (TCEP), sodium sulfide, sodium hydroxide and polyethylene glycol 400 (PEG 400) were all purchased at ≧99% purity (Fischer Scientific). Orthorombic reagent elemental sulfur (S⁰-E) at the highest available purity and colloidal sulfur (S⁰-CS), 80% w/w S⁰ were purchased from Sigma-Aldrich. Microthiol® (S⁰-MS), a water-dispersable, wettable powder, 80% w/w S⁰ fungicide formulation from Cerexagri-Nisso (King of Prussia, Pa.) was used; Alka-Seltzer tablets (Bayer Healthcare, Morristown, N.J.) and simethicone tablets (Quality Choice Extra-Strength Gas Relief, Novi, Mich.) were purchased locally. Ultra high purity nitrogen gas was used (Airgas, Ithaca, N.Y.). Distilled de-ionized water was used for all experiments. Two commercial suppliers of H₂S detection tubes were utilized: Sulfur Stick™ Cat No. 99-001 and 99-005 (Sang Il Int'l Corp, South Korea) and Gastec 4LT, 4LL and 4H (Nextteq, Tampa, Fla.). The detection tubes rely on a colorimetric reaction within the tube between evolved H₂S and a metal salt, either mercury chloride (Gastec 4LT detection tube) or lead acetate (all other detection tubes) adhered to a proprietary, inert matrix. The length of the tube darkened is linearly proportional to the quantity of H₂S evolved, where a change of 0.5 mm (the smallest detectable change), is equivalent to 0.005 μg, 0.1 μg and 5 μg of S⁰ on 4LT, 4LL and 4H tubes respectively.

### 2.1.2 Preparation of H₂₅Calibration Standards

A S²⁻ stock solution was prepared using a Silver/Sulfide electrode (Orion Cat No. 9616BNWP) according to the electrode manufacturer's specifications. Briefly, 100 g of Na₂S*9H₂O was dissolved in 100 g water, and diluted 1:100 in deaerated 1M NaOH. The true concentration of S²⁻ was established by titration against a 0.1 M Pb(ClO₄)₂ solution (Orion Cat No. 948206). The stock solution was kept refrigerated and retested weekly. Calibration standards were prepared in duplicate over appropriate ranges for each sulfide detection tube by addition of stock solution to deaerated buffer. The buffer composition is described below. Standards were deaerated initially by N₂ gas sparging and in later experiments by addition of Alka-Seltzer tablets. Dissolved O₂ was <0.1 μg mL⁻¹ determined by a Hach LDO handheld dissolved oxygen meter (Loveland, Colo.).

### 2.1.3 Preparation of S⁰ Calibration Standards

The methodology for preparing S⁰-E standards in PEG 400 was adopted from a previous report [18]. Reagent grade S⁰-E was dissolved in PEG 400 while stirring in a 100° C. water bath to prepare a 3.2 mg mL⁻¹ stock solution, which was serially diluted in PEG 400 to make 0.032 and 0.32 mg mL⁻¹ solutions. These solutions were then used to create calibration standards at the rates described below. The solutions were held at 80° C. prior to use to prevent precipitation. Stock solutions of S⁰-MS and S⁰-CS were prepared by suspending the formulation in water at S⁰ concentrations (w/w) equivalent to those for S⁰-E and were stirred prior to use.

### 2.2 Optimization of Methodology

### 2.2.1 H₂S Measurement Apparatus

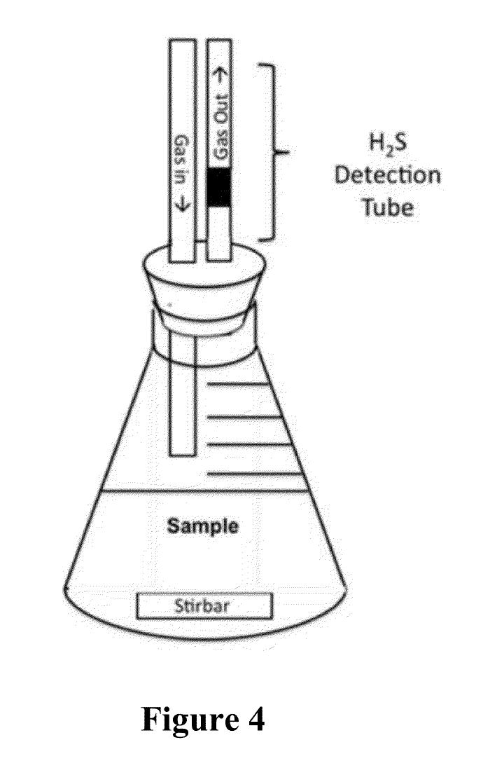

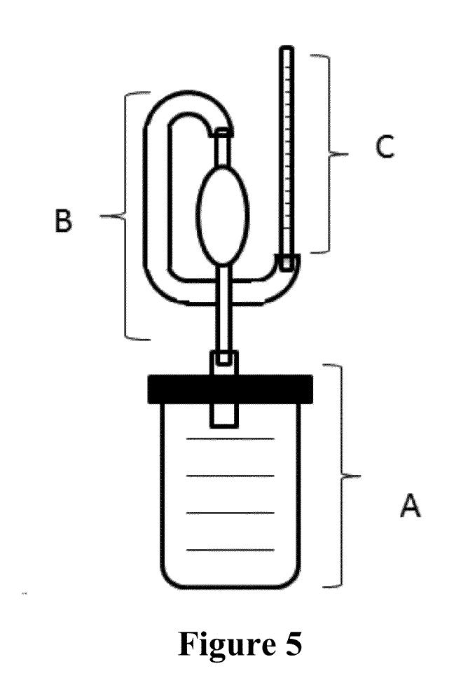

Two apparatus for measuring H₂S in solution were compared. Apparatus #1 was adopted from Park [19] (FIG. 4). Briefly, the headspace of a 500 mL Erlenmeyer flask was sparged with N₂ gas through a H₂S detection tube while the sample is vigorously stirred with a stir bar. Apparatus #2 was adapted from a protocol described by a commercial vendor of H₂S detection consumables [20]. A 120 mL glass flask containing the liquid sample was sparged by successive addition of two Alka-Seltzer tablets 5 min apart, which generated CO₂. The effluent was directed to an H₂S detection tube connected to the reaction flask via a short piece of silicone tubing. Contamination due to foaming was avoided by use of a 5 mL volumetric glass pipette between the reaction flask and detection tube (FIG. 5) and by addition of silicone oil or a crushed simethicone-containing tablet to the sample.

### 2.2.2 Evaluation of Reducing Agents

The effectiveness of several reducing agents in reducing S⁰ to S²⁻ was tested: glutathione, cysteine, mercaptoethanol, DTT, and TCEP. S⁰-E dissolved in PEG 400 (3.2 mg mL⁻¹) was added to 200 mL of 5 mg mL⁻¹ citric acid to yield a final concentration of 0.25 μg mL⁻¹ S⁰. The sample was adjusted to pH 11 with 1M NaOH, a reducing agent (20 mM) was added, and the sample was incubated at 50° C. for 30 minutes. Then, the pH was adjusted to 3.0 using 1M phosphoric acid and H₂S was quantified using Apparatus #1, described above. The yield of H₂S from S⁰-E was determined by comparing the response achieved from S⁰-E standards to H₂S standards.

### 2.2.3 Optimization of pH for Concurrent Formation/Quantification of H₂S

Buffered solutions of 5 g L⁻¹ citric acid were prepared over a range of pH values from 3.0 to 10.0 by adjustment with 1M NaOH. S⁰-E dissolved in PEG 400 (3.2 mg mL⁻¹) was added to 200 mL of 5 mg mL⁻¹ citric acid to yield a final concentration of 0.25 μg mL⁻¹ S⁰. DTT was then added to yield a final concentration of 20 mM, the sample incubated at 50° C. for 30 min., and H₂S quantified by Apparatus #1.

### 2.2.4 Optimization of Sample Pre-Treatment with PEG 400

H₂S recoveries were determined from a S⁰-MS calibration standard (2 μg mL⁻¹ as S⁰). First, different ratios of PEG 400 to sample volume (1:9, 1:4, 1:2, 1:1, 2:1 3:1, 4:1, 6:1, 9:1) were prepared, heated to 80° C. for 10 min., and then analyzed for S⁰. Then, using the optimal PEG 400-to-sample ratio so determined (1:4), the effect of temperature on S⁰ recovery was evaluated at 22, 30, 40, 55, 65, 70, 80, 90, and 100° C. Finally, the effect of extraction time was evaluated (2, 3, 4, 5, 7.5, 15, 30 min.) at the optimum temperature of 80° C. Analyses were done in duplicate, using Apparatus #2, the previously optimized S⁰ protocol, and Gastec 4LL detection tubes.

### 2.2.5 Optimized S⁰ Analysis Methodology Used to Test Recovery, Detection Limits, and Interferences

A 1 to 5 g aqueous sample or 1 g dry sample (e.g., drywall) is added to PEG 400 at a 1:4 ratio in a 120 mL flask and heated in a 80° C. water bath for 5 minutes to disperse S⁰. The sample is periodically agitated during heating. Water is added to bring the final volume to 80 mL, and the sample is agitated until the contents are evenly dispersed, about 30 seconds. An Alka-Seltzer tablet is added to deaerate the flask and capped as described above (Apparatus #2, FIG. 5). After 5 min. the lid is removed, DTT is added to yield a final concentration of 2 mM. An Alka-Seltzer tablet is added, and the lid immediately replaced. A second tablet is added after 5 min. After bubbling subsides, the H₂S concentration is determined by the length of color change along the colorimetric H₂S detection stick.

### 2.3 Linearity, Lower Limit of Detection (LLOD) and Quantification (LLOQ)

The linear range was determined on water samples (5 g) for three commercial Gastec tubes at appropriate concentrations of PEG 400-dissolved S⁰-E for each tube: 4LT (0, 0.01, 0.02, 0.03, 0.05 and 0.1 μg g⁻¹) 4LL (0, 0.1, 0.2, 0.5, 1.0 and 2.0 μg g⁻¹) and 4H (0, 2, 4, 6, 12, 24, 48 and 100 μg g⁻¹). Each concentration was run in replicate (n=5). The signal independent noise (σᵢ) was determined by Pallesen's method. The LLOQ was defined as 10*σᵢ the LLOD was defined as 3*σᵢ.

### 2.4 Evaluation of Potential Interferences

Analyses of grape macerate were run in duplicate using the optimized methodology and 4LT detection tubes. Prior to analysis, grape macerates were spiked with one of two suspected interferences: SO₄²⁻ in the form of CaSO₄ (560 mg L⁻¹ as SO₄²⁻) or HSO₃⁻ in the form of potassium metabisulfite (1000 mg L⁻¹ as SO₂).

### 2.5 S⁰ Recovery from Complex Matrices

### Grapes and Drywall

Chardonnay grapes were sourced from a local vineyard (Geneva, N.Y.) and homogenized in a Waring blender with an equal weight of water. Niagara grape juice (Welch's, purchased at local supermarket) was used for the juice matrix. Drywall samples were purchased from Home Depot (Pittsburgh, Pa.), the paper backing removed, and the samples pulverized prior to use. Recovery spikes were analyzed with S⁰-E (2, 5 and 10 μg g⁻¹ as S⁰) in juice and both S⁰-E and S⁰-MS (2, 5 and 10 μg g⁻¹ as S⁰) in grape samples. Drywall recovery spikes of S⁰-E and S⁰-CS were also evaluated. One gram samples were used for juice and grape recovery experiments, and 1 and 2.5 g samples for drywall recovery experiments. Recovery spikes were performed in triplicate with a 4LL detection tube.

### 2.6 Statistics

Minitab and SAS JMP were used for statistical analysis. Normalized coefficients of variance (% CV) were calculated as the standard deviation divided by the mean. Difference of means testing was performed by Tukey HSD.

### 3. Results and Discussion

### 3.1 Comparison of Apparatus for H₂S Detection

Initial methods were developed using an apparatus similar to that described by Park (Apparatus #1): H₂S was sparged from a sample by an external gas source. By using Alka-Seltzer tablets for buffering, de-aerating, and sparging samples, the external gas source could be eliminated (Apparatus #2, FIG. 5). Furthermore, analysis times for H₂S could be reduced to 15 minutes (data not shown) versus ≧60 min in previous reports [19][21], likely because of the smaller bubbles and improved mass transfer achieved with the tablets. Linear responses were achieved for H₂S calibration standards in concordance with manufacturers' claims and a previous report [21]. Using reagent grade potassium bicarbonate and citric acid in place of Alka-Seltzer tablets yielded similar results, but was less convenient and also resulted in a more rapid evolution of CO₂, which can dislodge the detection tube or, if large amounts of reagent are used, cause the apparatus to explode. Both manufacturers' detection tubes were found to be effective at measuring H₂S, but the Gastec tubes were utilized for method development due to their wider dynamic range compared to the Sulfur Stick™

### 3.2 Evaluation of Reducing Agents

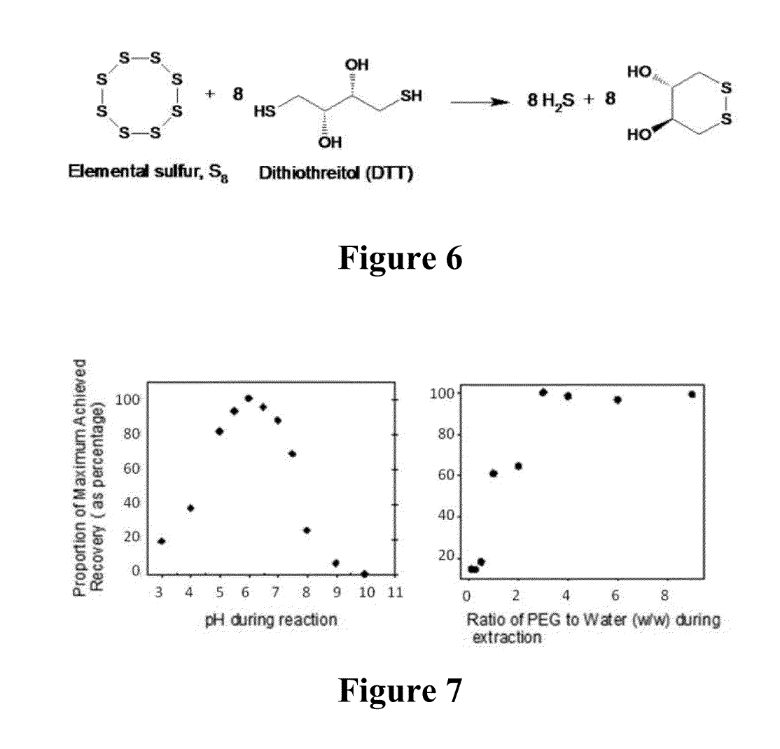

The ability of thiols to reduce S⁰ to H₂S has been reported in both abiotic and enzymatic systems [22, 23] but this concept has not been utilized previously in a selective method for converting S⁰ to S²⁻ for ultimate S⁰ quantification. Reducing agents were screened by addition to S⁰-E calibration standards under alkaline conditions, and the H₂S evolved quantified in acidic conditions using the Gastec tubes. DTT was found to efficiently convert S⁰-E to H₂S, with a recovery of 109±9.2% relative to that for sulfide calibration standards obtained under optimized assay conditions. The recovery achieved with monothiols (20 mM glutathione or 20 mM cysteine) was 18% and 14%, respectively, of the recovery with DTT under non-optimized conditions (Table 1). Recovery with these monothiol reagents did not improve with prolonged reaction time (>15 min) and improved only slightly with a 10 fold increase in reducing agent concentration. Previous work on the reaction of glutathione with S⁰ had observed a similar conversion rate of S⁰ to S²⁻ of ˜20% [23]. Monothiol reducing agents are reported to yield mixed disulfides when combined with other thiols in vitro, resulting in formation of mixed di- or trisulfides (or larger polymers) and non-quantitative recovery of H₂S from S⁰ [22]. By comparison, DTT forms a stable cyclic disulfide upon oxidation [24]. The expected reaction between DTT and S₈, the most common form of elemental sulfur, is shown in FIG. 6. TCEP, a common alternative to DTT for reducing disulfide bonds, resulted in poor recovery (9%). Mercaptoethanol was determined to be unacceptable, as it is semi-volatile and interfered with the detection tubes at the high concentrations employed.

TABLE 1
Conversion of S⁰ to S²⁻ with Different Reducing Agents

| Reducing agent | % conversion | SD |
|---|---|---|
| DTT | 100 | 6.4 |
| Glutathione | 18.2 | 1.8 |
| Cysteine | 13.6 | 1.3 |
| TCEP | 8.9 | 1.4 |
| β-mercaptoethanol | N/A^{b} | |

^{a}% conversion calculated as (mol H₂S detected mol⁻¹ S⁰ added), normalized to DTT recovery (100%). The % conversion for DTT with the optimized methodology was 109% ± 9.
^{b}β-mercaptoethanol resulted in interferences on sulfur sticks and conversion could not be determined.

### 3.3 Optimization of pH

In the initial evaluation of reducing agents, the reduction step was performed under alkaline conditions (pH 11) to increase the concentration of the thiolate forms of DTT (pKₐ=9.2, 10.1). However, the quantification step requires low pH to favor volatilization of H₂S (pKₐ=7). Using DTT, we investigated the appropriateness of performing both reduction and quantification steps at a single pH. Near-quantitative recovery was observed when concurrent reduction/quantification was performed at pH 6, and >80% recovery was achieved across the range of pH 5-7 (FIG. 7). A similar optimum pH range (approximately 5.5-7) has been reported previously for the reaction of glutathione with S⁰ [23]. For pH>7, recovery dropped precipitously, likely because HS⁻ species were favored at these higher pH values, resulting in poor mass transfer to the detection tube. Conveniently, Alka-Seltzer tablets are buffered to pH=6.05, and thus the target pH can be achieved by adding an Alka-Seltzer tablet to the diluted sample, with the additional benefit of simultaneously deaerating the sample and removing endogenous volatile interfering compounds (e.g., H₂S) prior to addition of the reducing agent. It is expected that other reducing agents such as dithioerythritol (DTE), glutathione, cysteine, tris(2 carboxyethyl)phospine (TCEP), and the like would work as DTT under these same conditions.

### 3.4 Optimizing Dispersion of S⁰ in PEG 400

In initial trials with recovery spikes, the recovery of S⁰-MS was only ˜20% of that which could be achieved with S⁰-E calibration standards and the theoretical maximum, even when water was used as the matrix (data not shown). Because the major difference in these two experiments was that S⁰-E was dispersed in PEG 400 prior to addition of the reducing agent, we adopted an initial step in which the sample is first combined with PEG 400, which has been described elsewhere as an effective co-solvent for dispersing S⁰ [18]. While several previous assays have utilized water-immiscible (and hazardous) solvents like CS₂, CCl₄, and toluene for extraction of S⁰, quantifying S⁰ directly in the sample allows a water-miscible and safer co-solvent (i.e., PEG 400) to be used instead. Using S⁰-MS (an S⁰ containing fungicide), we obtained maximum recovery with a ratio of 1 part sample per >3 parts PEG 400, and then incubated the mixture at temperatures between 65-100° C. for 5 min. prior to the reduction/quantification steps (FIG. 6). To ensure samples were well within the optimum ranges, a sample:PEG 400 ratio of 1:4 and extraction temp of 80° C. were used.

### 3.5 Linearity, LLOQ/LLOD, and Comparison to Other Methods

Linear ranges, LLOQ, LLOD, and other figures of merit for each detection tube are summarized in Table 2.

TABLE 2
Detection Limit and Quantification Ranges for Detection Tubes

| Detection | | LLOD | Linear range | | Correction | | |
|---|---|---|---|---|---|---|---|
| tube | Reagent | (μg g⁻¹)^{a} | (μg g⁻¹)^{a} | Linear regression^{b} | (mm)^{b} | % CV^{d} | r² |
| Gastec 4LT | HgCl₂ | 0.01 | 0.03-0.10 | 0.0127x − 0.276 | 21.7 | 9% | 0.998 |
| Gastec 4LL | Pb(CH3COO)₂ | 0.036 | 0.12-4.0 | 0.234x − 0.435 | 1.9 | 7% | 0.997 |
| Gastec 4HT | Pb(CH3COO)₂ | 1.81 | 6-100 | 9.20x + 2.91 | 0 | 7% | 0.996 |

^{a}Lower Limit of Detection, determined with 5 g water samples and S⁰-E spikes.
^{b}Best fit line for linear regression of “mm tube darkened” vs. “ug g⁻¹ sulfur”
^{c}Correction value accounts for background signal inherent in the test with no S⁰ addition, calculated from the x-axis intercept, due to interference from the Alka-Seltzer tablet.
^{d}% CV (mean % RSD) calculated for calibration points within quantification range.

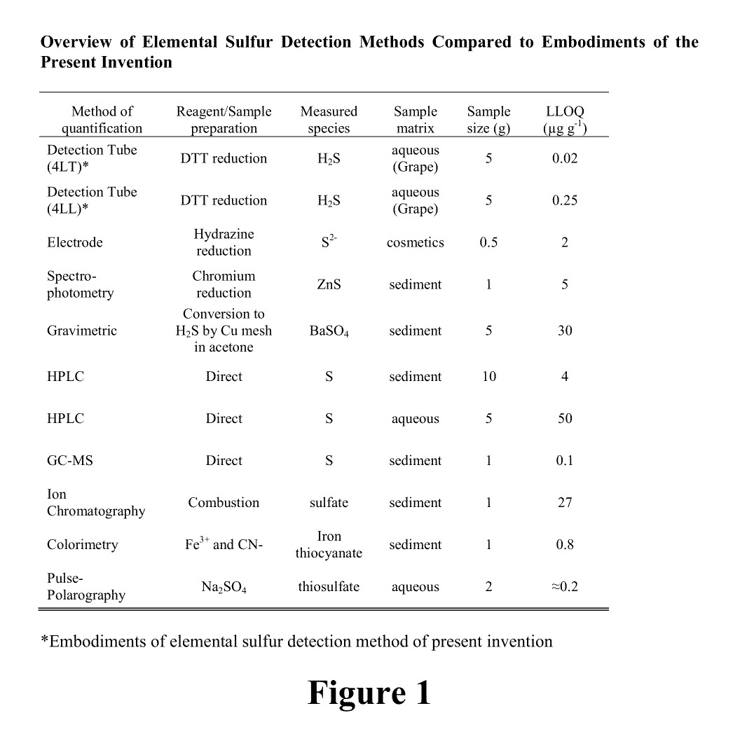

Good linearity (r²>0.99, average CV<10%) was achieved over an order of magnitude for the 4LL (0.12-4.0 μg g⁻¹) and 4H (6-100 μg g⁻¹) detection tubes. The linear range for the 4LT tubes was more limited (0.03-0.10 μg g⁻¹). By selecting an appropriate detection tube, a linear range from 0.03-100 μg g⁻¹ in 5 g of buffer could be achieved, i.e., 0.1-500 μg of S⁰. Using Pallesen's method, the LLOQ was calculated for 4LT (0.03 μg⁻¹), 4LL (0.12 μg⁻¹) and 4H (6.0 μg g⁻¹) detection tubes for a 5 g sample. Similar LLOQ were achieved for the 4LL tubes with S⁰-MS additions to grape samples (data not shown). The LLOQ of 4LL and, especially, the 4LT tubes was limited by background signal, likely due to interferences from endogenous S⁰ in the Alka-Seltzer tablets, described in more detail below. Even with this caveat, we can achieve a LLOQ well below 10 μg g⁻¹ S⁰ with our optimized methodologies using either 4LL or 4LT tube thresholds, the concentration associated with potential H₂S formation in drywall [3] and winegrapes [2]. The detection limits of our method are comparable to or better than other wet chemical and chromatographic methods despite its minimal time and equipment requirements [8, 9, 25, 26] (see FIG. 1). For example, the lowest LLOQ previously reported was with GC-MS (LLOQ=0.1 μg g⁻¹)[8], but this approach requires both specialized equipment and organic solvent extraction/pre-concentration prior to analysis. In principle, GC could also be coupled to sulfur-selective detectors like chemiluminescence or flame photometric detectors for quantification of S⁰, although to our knowledge this has not been reported. However, this approach would still have similar equipment and sample preparation demands as GC-MS. Wet chemical methods generally achieve poorer LLOQ, e.g., oxidation of S⁰ to Fe(SCN)₆³⁻ followed by colorimetric detection achieves an LLOQ of 0.8 μg g⁻¹, while also demanding toxic reagents and do not selectively reduce S⁰ [4, 9]. Our strategy of reducing S⁰ to S²⁻ prior to quantification has been previously described, but the reducing agents employed are less desirable. For example, S⁰ can be reduced to S²⁻ by Cr²⁺, which poses safety concerns as well as poor recovery under some conditions; Cu⁰ first requires an acetone extraction [13]; and hydrazine hydrate [25] has health and safety concerns related to its use. In addition, Cr²⁺ has been demonstrated to reduce sulfate to H₂S, which would be problematic with both drywall and grape samples [27]. Measurement of S²⁻ by sulfide tube technology was adopted instead of other methods such as sulfide ion-specific electrode [28] and sulfide traps [9] for a variety of reasons, including low cost, ease of use, lower limits of quantification, and better selectivity compared to one or both of these alternatives. In summary, our current approach requires no extraction or pre-concentration steps, minimally toxic reagents, and no specialized equipment while still achieving detection limits comparable to the best existing methods.

### 3.6 Evaluation of Potential Interferences

SO₂ can reportedly interfere with the performance of sulfide detection tubes; however, at the optimized pH range (pH=5-7), SO₂ exists primarily as non-volatile HSO₃, and does not interfere with analyses. With our optimized methodology, we observed no interference on the 4LT tubes with spikes of SO₄²⁻ in the form of gypsum (560 mg L⁻¹ as SO₄²⁻) and HSO₃⁻ in the form of potassium metabisulfite (1000 mg L⁻¹ as SO₂). The HgCl₂ based tubes (4LT) are reported to react with methyl mercaptan [21], and the presence of endogenous mercaptans or H₂S could yield incorrectly high measurements. Additionally, O₂ in the sample or buffer could oxidize H₂S and reduce recovery. These problems are avoided by the initial addition of an Alka-Seltzer tablet to simultaneously degas and buffer the sample prior to addition of the reducing agent. However, this step could also convert disulfides to mercaptans, again resulting in interferences for the HgCl₂ tubes. Thus, as a general caveat, we would not recommend using HgCl₂ based sulfide detection tubes in cases where interferences from mercaptans are possible. Finally, we observed a small signal in blanks, equivalent to 0.05 μg g⁻¹ S⁰ (Table 2). Substitution of reagent grade potassium bicarbonate and citric acid in place of Alka-Seltzer tablets yielded no detectable interference, suggesting that the tablets likely contain a small amount of S⁰ impurity.

### 3.7 S⁰ Recovery in Real Matrices

Recovery spikes of S⁰ in grape and juice samples (2, 5, 10 μg g⁻¹ added to 1 g samples, n=5) were evaluated (Table 3). Recoveries ranged from 90-95% for S⁰-E and from 82-88% for S⁰-MS. The recovery spikes of S⁰ used were at representative concentrations for residues reported to cause production of off-aromas during fermentations [2, 29]. We observed similarly good recoveries (>90%) for spikes of 1, 5 and 10 μg g⁻¹ S⁰-E and 4 and 10 μg g⁻¹ of S⁰-CS into 1 g of drywall matrix, where 10 μg g⁻¹ has been suggested as a limit for S⁰ in drywall [3]. Recovery of S⁰-E spikes to 2.5 g drywall samples (0.8 and 2.4 μg g⁻¹) was non-quantitative, ˜70%, although good reproducibility was achieved.

TABLE 3
Recovery of S⁰ Spikes from Complex Matrices

| | Sulfur | Sulfur spike | Recovery | CV |
|---|---|---|---|---|
| Matrix | form | (μg g⁻¹) | (%, mean) | (%) |
| Juice (1 g) | S⁰-E | 2, 5, 10 | 93.4 | 7.4 |
| Grapes (1 g) | S⁰-E | 2, 5, 10 | 92.7 | 9.8 |
| Grapes (1 g) | S⁰-MS | 2, 5, 10 | 84.7 | 10.2 |
| Drywall (2.5 g) | S⁰-E | 0.8, 2.4 | 74.9 | 8.1 |
| Drywall (1 g) | S⁰-E | 1, 5, 10 | 98.5 | 9.3 |
| Drywall (1 g) | S⁰-CS | 4, 10 | 106.6 | 6.9 |

### 4. CONCLUSION

The S⁰ quantification assay reported here represents an inexpensive and convenient alternative to existing methodologies. The equipment cost is <$50 and the cost of consumables is ˜$10/run, with potentially lower costs achievable by recycling detection tubes. Individual analyses require <15 minutes each, can be performed with minimal laboratory facilities and can be learned by unskilled practitioners with minimal training. The waste generated is mostly benign, although the microgram quantities of Hg or Pb in the sulfide detection tubes may require special disposal in some regions. Limits of quantification are comparable to the best reported from chromatographic and colorimetric methods, despite requiring no pre-concentration, extraction, or specialized equipment and can be further improved by using high purity reagents in place of the more convenient Alka-Seltzer tablets. Acceptable recovery could be achieved in diverse matrices, and the method appears to be sufficiently robust and accurate for general use in quantification of S⁰ in environmental samples. Finally, we see potential for adopting the methodology into more convenient colorimetric tests for semi-quantitative or qualitative analyses of S⁰ in complex samples, e.g., with colorimetric test-strips.

### Example 2

### Measuring Sulfur Residue in Grape Musts

The methods and kits of the present invention can been used to measure elemental sulfur residues on grapes during ripening. Provided below is one example of this approach.

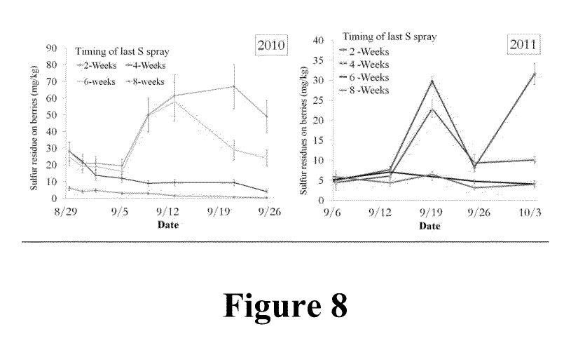

This approach has been used to measure elemental sulfur residue persistence in field trials in the Finger Lakes region of New York. A sulfur containing spray was applied and ceased at 2, 4, 6, and 8-weeks prior to harvest in both 2010 and 2011. Elemental sulfur residues over 2 mg/kg were observed in both years even for the 6-wk treatment, which may result in increased H₂S production in some cases. Data from this example is shown in the FIG. 8. This approach could be used by growers to determine when to cease sulfur spraying in vineyards.

### Example 3

### Measuring Sulfur Residues in Grape Musts

The methods and kits of the present invention have been used to measure sulfur on grapes and their resulting musts, following clarification. Provided below are results from one experimental test.

Table 4 contains data on sulfur (S⁰) residues on differently treated Chardonnay grapes and musts. Among treatments, the rate and cessation date of S⁰ sprays was varied. The data can then be used by vineyard managers or winemakers to determine appropriate times to cease S⁰ sprays to prevent excess residues at harvest, and to determine the effects of clarification or other pre-fermentation practices on sulfur residues.

TABLE 4
Sulfur residue (S⁰) on fruit and in the clarified must of Chardonnay grapes
(collected from Finger Lakes region, 2009)

| | | Timing of | | | | |
|---|---|---|---|---|---|---|
| | | final | | | | |
| | | application | | | | |
| | | (days | Must | | Fruit | |
| Application | Date of S⁰ | before | mean | | mean | |
| rate of S⁰ | application | harvest) | (μg/g) | SD | (μg/g) | SD |
| Control | Control | | 0.0 | 0.0 | 0.0 | 0.0 |
| 2.69 kg/ha | Aug. 8, 2009 | 68 | 0.1 | 0.1 | 0.2 | 0.2 |
| 2.69 kg/ha | Sep. 3, 2009 | 40 | 0.4 | 0.1 | 1.5 | 0.4 |
| 2.69 kg/ha | Oct. 2, 2009 | 12 | 6.8 | 0.7 | 43.4 | 7.5 |
| 5.38 kg/ha | Aug. 6, 2009 | 68 | 0.0 | 0.0 | 0.2 | 0.7 |
| 5.38 kg/ha | Sep. 3, 2009 | 40 | 0.4 | 0.3 | 1.3 | 0.7 |
| 5.38 kg/ha | Oct. 2, 2009 | 12 | 5.2 | 0.9 | 51.6 | 8.1 |

### REFERENCES

Citation of a reference herein shall not be construed as an admission that such reference is prior art to the present invention. As used herein, certain citations to references are indicated as numerals or alphanumerical symbols in parentheticals or brackets, and are further described in the “References” listing set forth below. The following references, to the extent that they provide exemplary procedural or other details supplementary to those set forth herein, are specifically incorporated herein by reference:
A1. Wenzel, K. Die HPLC-Bestimmung von elementarem Schwefel in Lebensmitteln. Zeitschrift für Lebensmitteluntersuchung und-Forschung A 1980, 170, 5-6.
A2. U.S. Consumer Product Safety Commission and U.S. Department of Housing and Urban Development Interim Guidance—Identification of Homes with Corrosion from Problem Drywall—Revision 1. 2010,
A3. Kamyshny Jr, A.; Borkenstein, C. G.; Ferdelman, T. G. Protocol for Quantitative Detection of Elemental Sulfur and Polysulfide Zero-Valent Sulfur Distribution in Natural Aquatic Samples. Geostandards and Geoanalytical Research 2009, 33, 415-435.
A4. Kwasniewski, M. T.; Allison, R. B.; Wilcox, W. F.; Sacks, G. L. Convenient, inexpensive quantification of elemental sulfur by simultaneous in situ reduction and colorimetric detection. Analytica Chimica Acta 2011, 703, 52-57
A5. Bartlett, J. K.; Skoog, D. A. Colorimetric determination of elemental sulfur in hydrocarbons. Anal. Chem. 1954, 26, 1008-1011.
A6. Fabbri, D.; Locatelli, C.; Tarabusi, S. A new procedure, based on combustion to sulphate and ion chromatography for the analysis of elemental sulphur in sediments. Chromatographia 2000, 53, 119-121.
A7. Fossing, H.; Jørgensen, B. B. Measurement of bacterial sulfate reduction in sediments: evaluation of a single-step chromium reduction method. Biogeochemistry 1989, 8, 205-222.
A8. Wang, L. H.; Chin, C. Y. Determination of sulfur in cosmetic products using ion-selective electrode. Journal of Analytical Chemistry 2007, 62, 688-690.
A9. Hardman, A. F.; Barbehenn, H. E. Determination of free sulfur in rubber. Industrial & Engineering Chemistry Analytical Edition 1935, 7, 103-104.
A10. Nriagu, J. O.; Soon, Y. K. Distribution and isotopic composition of sulfur in lake sediments of northern Ontario. Geochim. Cosmochim. Acta 1985, 49, 823-834.
A11. Henshaw, P. F.; Bewtra, J. K.; Biswas, N. Extraction of elemental sulfur from an aqueous suspension for analysis by high-performance liquid chromatography. Anal. Chem. 1997, 69, 3119-3123.
A12. Chen, Y. W.; Joly, H. A.; Belzile, N. Determination of elemental sulfur in environmental samples by gas chromatography-mass spectrometry. Chem. Geol. 1997, 137, 195-200.
A13. Singhvi, R. Field Analysis of Elemental Sulfur in Drywall by BC/ECD. 2009, 2011, 1,www.drywallsymposium.com/Posters/Singhvi.pdf.
A14. Columbia Analytical Services Chinese Drywall Testing. 10/11, 1 www.caslab.com/Chinese-Drywall-Testing.
A15. Thomas, C. S.; Gubler, W. D.; Silacci, M. W.; Miller, R. Changes in elemental sulfur residues on Pinot noir and Cabernet Sauvignon grape berries during the growing season. Am. J. Enol. Vitic. 1993, 44, 205.
1. B. C. Rankine, J. Sci. Food Agric., 14 (1963) 79-91.
2. T. E. Acree, E. P. Sonoff, D. F. Splittstoesser, Am. J. Enol. Vitic., 23 (1972) 6.
3. U.S. Consumer Product Safety Commission and U.S. Department of Housing and Urban Development, www.cpsc.gov, (2010).
4. H. Troelsen, B. B. Jørgensen, Estuar. Coast. Shelf Sci., 15 (1982) 255-266.
5. T. J. Hurse, W. P. P. Abeydeera, Journal of Chromatography A, 942 (2002) 201-210.
6. R. E. Pauls, J. Chromatogr. Sci., 48 (2010) 283-288.
7. C. L. Crawford, H. Boudries, R. J. Reda, K. M. Roscioli, K. A. Kaplan, W. F. Siems, H. H. Hill Jr, Anal. Chem., 82 (2009) 387-393.
8. Y. W. Chen, H. A. Joly, N. Belzile, Chem. Geol., 137 (1997) 195-200.
9. A. Kamyshny Jr, C. G. Borkenstein, T. G. Ferdelman, Geostandards and Geoanalytical Research, 33 (2009) 415-435.
10. G. W. Luther III, A. E. Giblin, R. Varsolona, Limnol. Oceanogr. (1985) 727-736.
11. J. K. Bartlett, D. A. Skoog, Anal. Chem., 26 (1954) 1008-1011.
12. H. Fossing, B. B. Jørgensen, Biogeochemistry, 8 (1989) 205-222.
13. A. F. Hardman, H. E. Barbehenn, Industrial & Engineering Chemistry Analytical Edition, 7 (1935) 103-104.
14. R. A. Berner, Mar. Geol., 1 (1964) 117-140.
15. J. D. Cline, Limnol. Oceanogr., 14 (1969) 454-458.
16. P. F. Henshaw, J. K. Bewtra, N. Biswas, Anal. Chem., 69 (1997) 3119-3123.
17. D. Fabbri, C. Locatelli, S. Tarabusi, Chromatographia, 53 (2000) 119-121.
18. M. W. Brenner, J. L. Owades, Science, 119 (1954) 911.
19. S. K. Park, Journal of Microbiology and Biotechnology, 18 (2008) 1550-1554.
20. Hach Company, www.hach.com (2010)
21. M. Ugliano, P. A. Henschke, Anal. Chim. Acta, 660 (2010) 87-91.
22. D. G. Searcy, S. H. Lee, Journal of Experimental Zoology Part A: Comparative Experimental Biology, 282 (1998) 310-322.
23. E. Sluiter, Biochem. J., 24 (1930) 549.
24. W. W. Cleland, Biochemistry (N.Y.), 3 (1964) 480-482.
25. L. H. Wang, C. Y. Chin, Journal of Analytical Chemistry, 62 (2007) 688-690.
26. I. N. Azarova, A. G. Gorshkov, M. A. Grachev, E. N. Korzhova, A. N. Smagunova, Journal of Analytical Chemistry, 56 (2001) 929-933.
27. S. E. Mylon, H. Hu, G. Benoit, Anal. Chem., 74 (2002) 661-663.
28. D. G. Searcy, M. A. Peterson, Anal. Biochem., 324 (2004) 269-275.
29. M. Schutz, R. E. Kunkee, Am. J. Enol. Vitic., 28 (1977) 137.
30. R. W. Howarth, B. B. Jørgensen, Geochim. Cosmochim. Acta, 48 (1984) 1807-1818.
31. J. O. Nriagu, Y. K. Soon, Geochim. Cosmochim. Acta, 49 (1985) 823-834.
32. P. F. Henshaw, J. K. Bewtra, N. Biswas, Anal. Chem., 69 (1997) 3119-3123.
33. G. W. Luther III, T. M. Church, Mar. Chem., 23 (1988) 295-309.
34. R. Singh, G. V. Lamoureux, W. J. Lees, G. M. Whitesides, Methods Enzymol., 251 (1995) 167-173.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed is:

1. A method for quantifying elemental sulfur levels in a test sample, said method comprising the steps of:
providing a test sample comprising an unknown amount of elemental sulfur;
converting the elemental sulfur contained in the test sample into volatilized hydrogen sulfide using benign reagents and without prior need to purify the elemental sulfur in the test sample by extraction or other purification processes; and
determining the amount of volatilized hydrogen sulfide from the test sample in order to quantify the amount of elemental sulfur contained in the test sample,
wherein the amount of volatilized hydrogen sulfide produced in the converting step is proportionate to the amount of elemental sulfur contained in the test sample, and
wherein the converting and determining steps are performed substantially concurrently with one another.

2. The method according to claim 1, wherein the step of providing the test sample comprises the steps of:
mixing the test sample with a sufficient amount of a non-toxic dispersing agent under conditions effective to disperse the elemental sulfur contained in the test sample;
adjusting the pH of the test sample to a pH of between about 3.0 and about 9.0; and
deaerating the test sample.

3. The method according to claim 2, wherein the pH of the test sample is adjusted to a pH selected from the group consisting of between about 3.5 and about 8.5, between about 4.0 and about 8.0, between about 4.5 and about 7.5, between about 5.0 and about 7.0, between about 5.5. and 6.5, and about 6.0.

4. The method according to claim 2, wherein the non-toxic dispersing agent is selected from the group consisting of polyethylene glycol (PEG), polypropylene glycol (PPG), and the like.

5. The method according to claim 2, wherein the adjusting the pH step and the deaerating step are performed in a single step by adding to the test sample a sufficient amount of a weak acid/weak base mixture effective to adjust the pH of the test sample to between about 3.0 and about 9.0 and to deaerate the test sample.

6. The method according to claim 5, wherein the weak acid/weak base mixture comprises the following: (i) a mixture of citric acid and sodium bicarbonate; (ii) a mixture of citric acid, calcium chloride, and sodium bicarbonate; or (iii) bicarbonate or carbonate salts, either alone or in combination with other neutral salts or acids and effective for adjusting the pH of the test sample to between about 3.0 and about 9.0 and to generate carbon dioxide.

7. The method according to claim 1, wherein the step of converting the elemental sulfur contained in the test sample into volatilized hydrogen sulfide comprises the steps of:
treating the test sample with a sufficient amount of a mild reducing agent under conditions effective to convert the elemental sulfur to hydrogen sulfide; and
sparging the treated test sample with an inert gas to volatilize the hydrogen sulfide.

8. The method according to claim 7, wherein the mild reducing agent is selected from the group consisting of dithiotreitol (DTT), dithioerythritol (DTE), glutathione, cysteine, tris(2-carboxyethyl)phosphine (TCEP), and the like.

9. The method according to claim 7, wherein the inert gas of the sparging step is provided by adding to the treated test sample a weak acid/weak base mixture selected from the group consisting of: (i) a mixture of citric acid and sodium bicarbonate; (ii) a mixture of citric acid, calcium chloride, and sodium bicarbonate; and (iii) bicarbonate or carbonate salts, either alone or in combination with other neutral salts or acids and effective for adjusting the pH of the test sample to between about 3.0 and about 9.0 and to generate carbon dioxide.

10. The method according to claim 1, wherein the step of determining the amount of volatilized hydrogen sulfide from the test sample comprises:
directing substantially all of the volatilized hydrogen sulfide to a hydrogen sulfide detection component; and
using the hydrogen sulfide detection component to measure the amount of volatilized hydrogen sulfide produced from the test sample, wherein the amount of volatilized hydrogen sulfide measured by the hydrogen sulfide detection component is proportionate to the amount of elemental sulfur contained in the test sample.

11. The method according to claim 10, wherein the hydrogen sulfide detection component is sulfide detection tube or a colorimetric assay comprising a paper strip impregnated with a transition metal salt selected from the group consisting of lead sulfate, mercuric chloride, copper chloride, cadmium chloride, and the like.

12. The method according to claim 1, wherein the test sample is selected from the group consisting of plant materials, plant residues, plant liquids or juices, foodstuffs, drywall samples, soils, rocks, water samples, wastewater, petrochemicals, explosive residues, and the like.

13. The method according to claim 12, wherein the plant is any plant exposed to elemental sulfur or a pesticide comprising elemental sulfur.

14. The method according to claim 12, wherein the plant is selected from the group consisting of a fruit plant, a vegetable plant, a tuber or tuber-like plant, an ornamental plant, and a grain plant.

15. The method according to claim 12, wherein the plant is selected from the group consisting of grapes, strawberries, raspberries, blueberries, apples, cherries, peaches, nectarines, pears, hops, and the like.

16. A kit for converting elemental sulfur from a test sample into volatilized hydrogen sulfide in situ and quantifying the elemental sulfur levels in the test sample, said kit comprising:
(a) a collection of reagents comprising:
(i) a non-toxic dispersing agent effective to disperse elemental sulfur contained in a test sample;
(ii) a weak acid/weak base mixture effective to adjust the pH of the test sample to between about 3.0 and about 9.0 and to deaerate the test sample;
(iii) a mild reducing agent effective to convert the elemental sulfur to hydrogen sulfide without need for solvent extraction;
(iv) a sparging agent effective to produce an inert gas to volatilize the hydrogen sulfide; and
(v) a hydrogen sulfide detection component for quantifying the amount of volatilized hydrogen sulfide;
(b) a reaction chamber for reacting the test sample with the collection of reagents; and
(c) instructions for using the kit to convert elemental sulfur from a test sample into volatilized hydrogen sulfide in situ and to quantify the elemental sulfur levels in the test sample.

17. The kit according to claim 16, wherein said non-toxic dispersing agent is selected from the group consisting of polyethylene glycol (PEG), polypropylene glycol (PPG), and the like.

18. The kit according to claim 16, wherein said weak acid/weak base mixture comprises the following: (i) a mixture of citric acid and sodium bicarbonate; (ii) a mixture of citric acid, calcium chloride, and sodium bicarbonate; or (iii) bicarbonate or carbonate salts, either alone or in combination with other neutral salts or acids and effective for adjusting the pH of the test sample to between about 3.0 and about 9.0 and to generate carbon dioxide.

19. The kit according to claim 16, wherein said mild reducing agent is selected from the group consisting of dithiothreitol (DTT), dithioerythritol (DTE), glutathione, cysteine, tris(2-carboxyethyl)phosphine (TCEP), and the like.

20. The kit according to claim 16, wherein said sparging agent is a weak acid/weak base mixture selected from the group consisting of: (i) a mixture of citric acid and sodium bicarbonate; (ii) a mixture of citric acid, calcium chloride, and sodium bicarbonate; and (iii) bicarbonate or carbonate salts, either alone or in combination with other neutral salts or acids and effective for adjusting the pH of the test sample to between about 3.0 and about 9.0 and to generate carbon dioxide.

21. The kit according to claim 16, wherein said hydrogen sulfide detection component is a sulfide detection tube or a colorimetric assay comprising a paper strip impregnated with a transition metal salt selected from the group consisting of lead sulfate, mercuric chloride, copper chloride, cadmium chloride, and the like.

22. A method for quantifying elemental sulfur levels in a test sample, said method comprising the steps of:
(a) providing a kit according to claim 16;
(b) providing a test sample comprising an unknown amount of elemental sulfur; and
(c) using the kit to perform the steps of:
(i) converting the elemental sulfur contained in the test sample into volatilized hydrogen sulfide; and
(ii) determining the amount of volatilized hydrogen sulfide from the test sample in order to quantify the amount of elemental sulfur contained in the test sample, wherein the amount of volatilized hydrogen sulfide produced in the converting step is proportionate to the amount of elemental sulfur contained in the test sample, and wherein the converting and determining steps are performed substantially concurrently with one another.

23. The method according to claim 22, wherein the test sample is selected from the group consisting of plant materials, plant residues, plant liquids or juices, foodstuffs, drywall samples, soils, rocks, water samples, wastewater, petrochemicals, explosive residues, and the like.

24. The method according to claim 23, wherein the plant is any plant exposed to elemental sulfur or a pesticide comprising elemental sulfur.

25. The method according to claim 23, wherein the plant is selected from the group consisting of a fruit plant, a vegetable plant, a tuber or tuber-like plant, an ornamental plant, and a grain plant.

26. The method according to claim 23, wherein the plant is selected from the group consisting of grapes, strawberries, raspberries, blueberries, apples, cherries, peaches, nectarines, pears, hops, and the like.
